(19) United States
(12) Patent Application Publication
(10) Pub. No.: US 2026/0246418 A1
(43) Pub. Date: Aug. 20, 2026

(54) MULTILOBED DRIVELINE

(71) Applicant: ARRAY TECH, INC., Albuquerque, NM (US)

(72) Inventor: Jose Martin, Queen Creek, AZ (US)

(21) Appl. No.: 19/533,944

(22) Filed: Feb. 9, 2026

Related U.S. Application Data
(60) Provisional application No. 63/760,022, filed on Feb. 18, 2025.

(51) Int. Cl. H02S 20/32; F16C 3/03

(52) U.S. Cl. CPC H02S 20/32; F16C 3/03

(57) ABSTRACT

A driveline configured to transmit a rotational force to a torque tube in a solar tracker system may include an inner surface and outer surface defining a thickness of the driveline. Portions of the inner and outer surfaces may define four lobes arranged symmetrically about a central axis centered in and extending through the driveline and portions of the inner and outer surfaces may define four recesses arranged symmetrically about the central axis. Each recess may separate a lobe of the four lobes from another lobe of the four lobes.

### CROSS-REFERENCE TO RELATED APPLICATIONS

This patent application claims priority to and the benefit of United States Provisional Patent Application Serial No. 63/760,022, entitled MULTILOBED DRIVELINE, filed February 18, 2025, which is incorporated by reference in its entirety.

### FIELD

The present disclosure relates to solar energy production and more particularly to a multilobed driveline for use in a solar tracker system.

### BACKGROUND

Solar tracker systems typically include multiple solar tracker rows and operate by rotating photovoltaic (PV) modules secured to each solar tracker row to align the PV modules with the position of the Sun. As a result, the PV modules’ exposure to sunlight throughout the day may be increased. This functionality ensures that PV modules in solar tracker systems remain positioned to capture higher levels of solar radiation, which may enhance the overall efficiency of solar power generation.

Each solar tracker row may include one or more PV modules and a torque tube. The torque tube may provide horizontal support to the PV modules and may be coupled to the PV modules such that rotation of the torque tube rotates the PV modules. Support columns or piles driven into the ground may provide vertical support to the PV modules and the torque tubes. The solar tracker rows may be spaced apart at distances exceeding twenty feet such that a PV module of one solar tracker module does not cast a shadow on a PV module at a different solar tracker row.

The solar tracker system may include a motor that may exert a rotational force (e.g., torque) to rotate the PV modules at each solar tracker row. In order to rotate the PV modules at each solar tracker row, each solar tracker row may be coupled to another solar tracker row via a driveline assembly. Each driveline assembly may be rotated due to the rotational force from the motor, and each driveline assembly may be configured to transmit the rotational force from the motor to a torque tube at a solar tracker row such that the PV modules at the solar tracker rows are rotated to align with the position of the Sun. As the number of solar tracker rows in a solar tracker system increases and the length of the solar tracker system increases, the motor may be required to exert a higher rotational force to rotate each of the driveline assemblies. As a result, the rotational force experienced by each of the drivelines may increase.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Current driveline configurations may have a low torque capacity due to the geometry of the driveline, which may place constraints on the solar tracker system. A driveline having a low torque capacity may only be applied in a solar tracker system having a certain number of solar tracker rows without risking a failure of the driveline due to shear stress and/or torque. For example, although the motor may be capable of exerting a higher magnitude rotational force to operate a higher number of solar tracker rows and the other components of the solar tracker system may be designed to withstand the increased rotational force, the number of solar tracker rows that the motor may operate may be limited due to the torque capacity of the driveline. Furthermore, the torque capacity of current driveline configurations may limit the allowable distance between solar tracker rows. For example, the rotational force exerted by the motor may cause current drivelines to buckle and/or fail as the distance increases between solar tracker rows. Additionally, in some instances, drivelines may be telescopic with two different sections. Thus, the rotational force exerted by the motor may need to be transmitted from one section of the driveline to the other section, and current configurations may inadequately transmit the rotational force between the sections, resulting in inefficiencies.

Accordingly, there exists a need for a driveline assembly with a driveline that allows for a higher number of solar tracker rows to be operated by a motor in a solar tracker system and that allows for a greater distance between solar tracker rows. Furthermore, there exists a need for a driveline configuration that may efficiently transmit the rotational force exerted by the motor between different sections of the driveline in telescopic applications.

To compensate for the low torque capacity of current drivelines, the drivelines in a solar tracker system may be constructed out of a stronger material or the drivelines may be increased in size. However, both of these potential solutions may increase the cost of the driveline assembly because stronger materials may be more expensive and increasing the size of the driveline may increase the amount of material used.

Example embodiments of the present disclosure address problems experienced in solar tracker systems, including problems associated with driveline configurations. The disclosed embodiments may allow for an increased number of solar tracker rows to be operated by a single motor, may allow for greater distances (e.g., longer drivelines) between solar tracker rows, and/or may allow for efficient torque transfer in a telescopic driveline by providing a hollow four-lobed driveline configured to transmit a rotational force to a torque tube. The driveline may have a thickness defined by an inner surface and an outer surface. Portions of the inner and outer surfaces may define the four lobes, and the four lobes may be arranged symmetrically about a central axis centered in and extending through the driveline. The driveline may also include four recesses arranged symmetrically about the central axis and defined by portions of the inner and outer surfaces. Each recess may separate a lobe of the four lobes from another lobe of the four lobes.

The hollow design of the driveline may increase the polar moment of inertia allowing for an increased torque capacity, which may enable a motor to rotate a higher number of solar tracker rows. The four-lobed configuration may provide multiple contact points which may reduce the contact stress and the shear stress experienced by the driveline due to the rotational force exerted by the motor. The four-lobed configuration may be particularly beneficial in telescopic drivelines by distributing the rotational force from the motor through four contact points between the first section and the second section of the driveline allowing for increased torque transfer between the sections of the driveline. Furthermore, the thickness of the driveline may be configured such that the driveline may have sufficient buckling strength over the distance between solar tracker rows.

In some embodiments, each lobe of the four lobes may be convex relative to the central axis. In these and other embodiments, a distance from the central axis to the portion of the outer surface defining the lobe may be between about 25 millimeters and about 35 millimeters.

In some embodiments, each recess of the four recesses may be concave relative to the central axis and convex relative to an external axis. In these and other embodiments, a distance from the external axis to the portion of the outer surface defining the recess may be between about 5 millimeters and about 15 millimeters.

In some embodiments, the thickness of the driveline may be between about 1 millimeter and about 5 millimeters. In some embodiments, the thickness of the driveline may be uniform. In some embodiments, the thickness of the driveline may be nonuniform.

In some embodiments, the driveline may further include a plurality of interfaces defined by portions of the inner and outer surfaces of the driveline, and each interface may transition a recess of the four recesses into a lobe of the four lobes. In these and other embodiments, each lobe may be convex relative to the central axis, each recess may be concave relative to the central axis, and each interface may blend a curvature of a recess into a curvature of an adjacent lobe.

In some embodiments, each interface may have a radius between about 1 millimeter and about 6 millimeters. In some embodiments, the thickness of the driveline at each interface of the plurality of interfaces may be greater than the thickness of the driveline at the four recesses and the four lobes.

In some embodiments, the inner surface of the driveline, the outer surface of the driveline, the four lobes of the driveline, and the four recesses of the driveline may define, at least partially, a cross-sectional geometry of at least a portion of the driveline. In these and other embodiments, the driveline may include a first section having the cross-sectional geometry and a second section coupled to the first section. The second section may have a corresponding cross-sectional geometry to the cross-sectional geometry of the first section, and the second section may include four corresponding lobes and four corresponding recesses arranged symmetrically about the central axis such that at least a portion of the second section fits within the first section and rotation of either section transmits rotation to the other section. In some embodiments, the driveline may be between about 5 feet and about 40 feet in length.

In some embodiments, the driveline may be included in a driveline assembly, which may include a universal joint (U-joint) configured to be coupled on a first side to the driveline, configured to be coupled on a second side to a driveshaft, and configured to transmit the rotational force from the driveline to the torque tube.

A solar tracker system is also disclosed. The solar tracker system includes a first solar tracker row and a second solar tracker row. The first solar tracker row may include a first PV module, a first torque tube coupled to the first PV module such that rotation of the first torque tube rotates the first PV module, and a motor configured to exert a rotational force that rotates the first torque tube. The second solar tracker row may include a second PV module and a second torque tube coupled to the second PV module such that rotation of the second torque tube rotates the second PV module.

The solar tracker system may include a first driveline assembly coupling the first solar tracker row to the second solar tracker row. The first driveline assembly may include a first driveline configured to transmit the rotational force from the motor at the first solar tracker row to the second torque tube. The first driveline may include an inner surface and an outer surface, and the inner and outer surfaces may define a thickness of the first driveline. The first driveline may include four lobes and four recesses defined by portions of the inner and outer surfaces and arranged symmetrically about a central axis centered in and extending through the first driveline. Each recess may separate a lobe of the four lobes from another lobe of the four lobes. The first driveline assembly may also include a first U-joint coupling the first driveline to the motor, and the first U-joint may be configured to transmit the rotational force from the motor to the first driveline. The driveline assembly may further include a second U-joint coupling the first driveline to the second solar tracker row, and the second U-joint may be configured to transmit the rotational force from the first driveline to the second torque tube.

In some embodiments, the first solar tracker row may include a first gear drive mechanism coupled to the first torque tube and the second solar tracker row may include a second gear drive mechanism coupled to the second torque tube. In some embodiments, the second U-joint may be configured to transmit the rotational force to the second gear drive mechanism such that the second gear drive mechanism causes the second torque tube to rotate. In some embodiments, the first gear drive mechanism and the second gear drive mechanism may be slew drives, and each gear drive mechanism may include a worm gear.

In some embodiments, the first solar tracker row may be a middle row in the solar tracker system. In some embodiments, the first solar tracker row may be an end row in the solar tracker system.

In some embodiments, the solar tracker system may include a third solar tracker row, and the third solar tracker row may include a third PV module and a third torque tube coupled to the third PV module such that rotation of the third torque tube rotates the third PV module.

In these and other embodiments, the solar tracker system may include a second driveline assembly coupling the second solar tracker row to the third solar tracker row. The second driveline assembly may include a second driveline configured to transmit the rotational force from the first driveline to the third torque tube. The second driveline may include an inner surface and an outer surface, and the inner and outer surfaces may define a thickness of the second driveline. The second driveline may also include four lobes and four recesses defined by portions of the inner and outer surfaces of the second driveline and arranged symmetrically about a central axis centered in and extending through the second driveline. Each recess may separate a lobe of the four lobes from another lobe of the four lobes.

In these and other embodiments, the second driveline assembly may also include a third U-joint coupling the second driveline to the second solar tracker row, and a fourth U-joint coupling the second driveline to the third solar tracker row. The fourth U-joint may be configured to transmit the rotational force from the second driveline to the third torque tube. In some embodiments, the thickness of the second driveline may be less than the thickness of the first driveline.

Overall, the embodiments disclosed may improve solar tracker systems by providing a hollow four-lobed driveline with an increased torque capacity. The driveline may also reduce the contact stress and the shear stress experienced by the driveline due to the rotational force of the motor, particularly in telescopic drivelines by distributing the rotational force from the motor efficiently between the first and second sections of the driveline. The improved geometry of the driveline may allow for a higher number of solar tracker rows to be operated by a single motor and/or may allow for the length between solar tracker rows to be increased. As a result, solar tracker rows may be positioned in a solar tracker system without being constrained by the driveline and/or a higher number of solar tracker rows may be operated by a motor.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example solar tracker system including one or more solar tracker rows;

FIG. 2 illustrates a partial view of an example solar tracker system showing two solar tracker rows;

FIG. 3A illustrates a perspective exploded view of a solar tracker system including a driveline assembly, a motor, a gear drive mechanism, and a torque tube;

FIG. 3B illustrates a top exploded view of the solar tracker system illustrated in FIG. 3A;

FIG. 4A illustrates a perspective view of an example driveline;

FIG. 4B illustrates a cross-sectional view of the example driveline of FIG. 4A;

FIG. 4C, FIG. 4D, and FIG. 4E illustrate cross-sectional views of the example driveline of FIG. 4A showing various example dimensions of the driveline;

FIG. 5A and FIG. 5B respectively illustrate a perspective view and an exploded view of a portion of a driveline assembly including a driveline and a universal joint;

FIG. 6A illustrates a perspective view of an example driveline;

FIG. 6B illustrates a cross-sectional view of the example driveline of FIG. 6A;

FIG. 6C, FIG. 6D, and FIG. 6E illustrate cross-sectional views of the example driveline of FIG. 6A showing various example dimensions of the driveline;

FIG. 7A and FIG. 7B respectively illustrate a perspective view and an exploded view of a portion of a driveline assembly including a driveline and a universal joint;

FIG. 8A illustrates an example driveline including a first section and a second section coupled with the first section; and

FIG. 8B illustrates a cross-sectional view of the example driveline of FIG. 8A.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

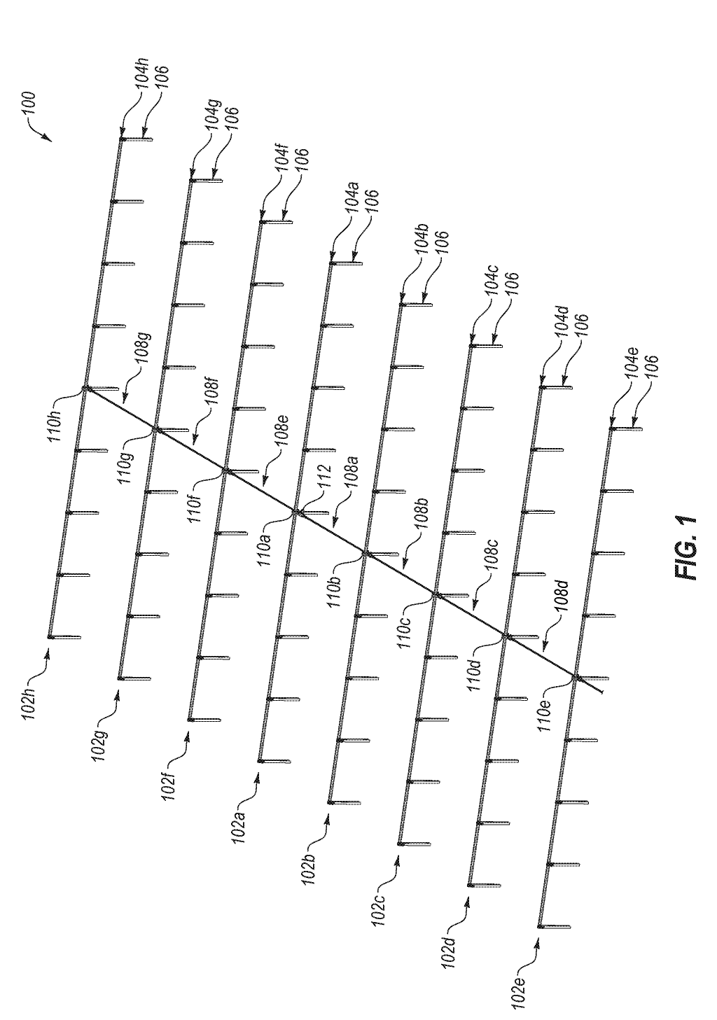

FIG. 1 illustrates an example solar tracker system 100. The solar tracker system 100 may include one or more solar tracker rows 102. Each solar tracker row 102 may include a torque tube 104 coupled to one or more PV modules (not shown) such that rotation of the torque tube 104 rotates the PV modules. For example, a first solar tracker row 102a may include a first torque tube 104a coupled to one or more first PV modules such that rotation of the first torque tube 104a rotates the first PV modules, a second solar tracker row 102b may include a second torque tube 104b coupled to one or more second PV modules such that rotation of the second torque tube 104b rotates the second PV modules, and/or a third solar tracker row 102c may include a third torque tube 104c coupled to one or more third PV modules such that rotation of the third torque tube 104c rotates the third PV modules. Thus, the torque tubes 104 may rotate the PV modules such that the PV modules may track the position of the Sun in the sky throughout the day. For example, as the Sun rises and early in the day, the PV modules may be rotated by the torque tubes 104 such that the PV modules are facing an easterly direction, around mid-day the PV modules may be rotated by the torque tubes 104 such that the PV modules are substantially horizontal, and as the Sun sets and later in the day, the PV modules may be rotated by the torque tubes 104 such that the PV modules are facing a westerly direction. Additionally or alternatively, the PV modules may be rotated by the torque tubes 104 in response to weather events such as hailstorms or snowstorms, for maintenance purposes, and/or in response to other factors other than to track the position of the Sun.

The solar tracker system 100 may also include one or more support columns (or piles) 106. The support columns 106 may be driven into the ground and may provide vertical support for the PV modules and the torque tubes 104. The torque tubes 104 may provide horizontal support for the PV modules.

In some embodiments, at least one of the solar tracker rows 102 may include a motor 112. For example, the first solar tracker row 102a may include the motor 112. In some embodiments, the motor 112 may be an electric motor such as an AC motor or a DC motor. In some embodiments, the motor 112 may be a brushed motor or a brushless motor. The motor 112 may exert a rotational force that may be transmitted to the torque tubes 104 such that the PV modules may be rotated.

The first solar tracker row 102a may include the motor 112 and may be placed at various positions in the solar tracker system 100. In some embodiments, and as illustrated in FIG. 1, the first solar tracker row 102a may be a middle row in the solar tracker system 100 such that there may be solar tracker rows 102 on both sides of the first solar tracker row 102a. In these and other embodiments, the rotational force exerted by the motor 112 may be transmitted in multiple directions. For example, and as illustrated in FIG. 1, the rotational force exerted by the motor 112 may be transmitted in a first direction from the first solar tracker row 102a to the second solar tracker row 102b, the third solar tracker row 102c, a fourth solar tracker row 102d, and/or a fifth solar tracker row 102e, and the rotational force exerted by the motor 112 may be transmitted in a second direction from the first solar tracker row 102a to the sixth solar tracker row 102f, the seventh solar tracker row 102g, and/or the eight solar tracker row 102h. It will be appreciated that the term middle row is used to encompass the first solar tracker row 102a having at least one solar tracker row 102 on either side of the first solar tracker row 102a. In some embodiments, the first solar tracker row 102a may have equivalent numbers of solar tracker rows 102 on either side of the first solar tracker row 102a, but in some embodiments the number of solar tracker rows 102 on either side of the first solar tracker row 102a may be different.

In some embodiments, the first solar tracker row 102a may be an end row in the solar tracker system 100. For example, the first solar tracker row 102a may be in the position of a fifth solar tracker row 102e or the eighth solar tracker row 102h, which may be end rows as illustrated in FIG. 1. Therefore, in some embodiments, other solar tracker rows 102 may be on only one side of the first solar tracker row 102a. In these and other embodiments, the rotational force exerted by the motor 112 may be transmitted in one direction.

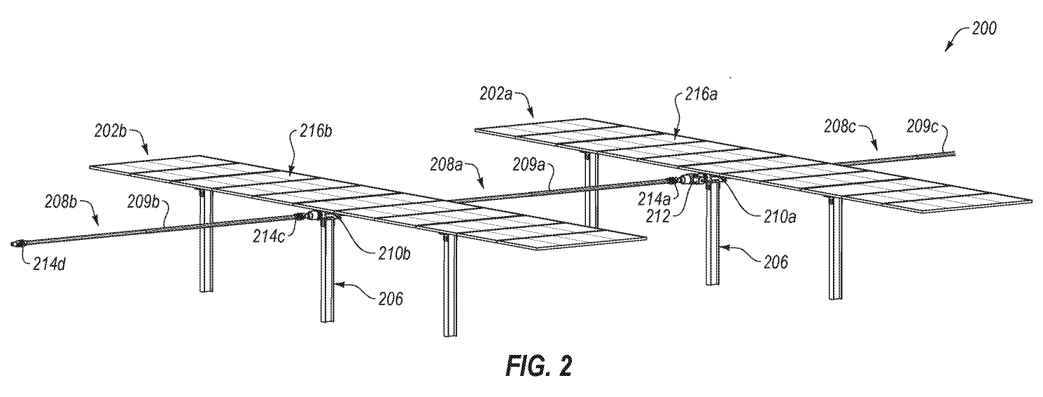

The solar tracker system 100 may include one or more driveline assemblies 108 coupling the solar tracker rows 102. For example, the first solar tracker row 102a may be coupled to the second solar tracker row 102b via a first driveline assembly 108a, and the second solar tracker row 102b may be coupled to a third solar tracker row 102c via a second driveline assembly 108b. The driveline assemblies 108 may include a driveline and one or more U-joints. The driveline assemblies 108 may transmit the rotational force from one solar tracker row 102 to the torque tube 104 at the next solar tracker row 102. For example, the first driveline assembly 108a may transmit the rotational force exerted by the motor 112 at the first solar tracker row 102a to the second torque tube 104b at the second solar tracker row 102b, and the second driveline assembly 108b may transmit the rotational force exerted by the motor 112 from the second solar tracker row 102b to the third torque tube 104c at the third solar tracker row 102c. The U-joints may couple the driveline assemblies 108 to the solar tracker rows 102 at each end of the driveline assemblies 108. For example, a first U-joint of the first driveline assembly 108a may couple the first driveline to the motor 112, and a second U-joint of the first driveline assembly 108a may couple the first driveline to the second solar tracker row 102b. The driveline assemblies 108 and/or components of the driveline assemblies 108 such as the driveline and the U-joints are described with more detail with reference to FIG. 2–FIG. 8B.

In some embodiments, each solar tracker row 102 may include a gear drive mechanism 110 coupled to the torque tube 104, and the gear drive mechanism 110 may cause the torque tubes 104 to rotate due to the rotational force exerted by the motor 112—thereby rotating the PV modules. For example, a first gear drive mechanism 110a may be coupled to the first torque tube 104a and may cause the first torque tube 104a to rotate due to the rotational force exerted by the motor 112, and a second gear drive mechanism 110b may be coupled to the second torque tube 104b and may cause the second torque tube 104b to rotate due to the rotational force exerted by the motor 112.

In some embodiments, the gear drive mechanism 110 may be a slew drive, a worm gear drive, a bevel gear drive, a planetary gear drive, a cycloidal drive, a helical gear drive, a harmonic drive, a spur gear drive, a rack and pinion drive, a combination of gear drive mechanisms, or any other suitable gear drive mechanism. For example, in some embodiments, the gear drive mechanisms 110 may be a slew drive including a worm gear. For instance, both the first gear drive mechanism 110a and the second gear drive mechanism 110b may be slew drives including a worm gear.

In some embodiments, the motor 112 may be directly coupled to at least one of the gear drive mechanisms 110. For example, the motor 112 may be directly coupled to the first gear drive mechanism 110a, and the rotational force exerted by the motor 112 may be directly transmitted from the motor 112 to the first gear drive mechanism 110a such that the first gear drive mechanism 110a rotates the first torque tube 104a. In some embodiments, the driveline assemblies 108 may couple the motor 112 to one or more of the gear drive mechanisms 110. For example, the driveline assemblies 108 between the solar tracker rows 102 may transmit the rotational force exerted by the motor 112 to the gear drive mechanisms 110. For instance, the first driveline assembly 108a may transmit the rotational force exerted by the motor 112 to the second gear drive mechanism 110b, which may rotate the second torque tube 104b thereby causing the second PV modules at the second solar tracker row 102b to rotate.

In an example operation of the solar tracker system 100, the motor 112 at the first solar tracker row 102a may exert a rotational force. The motor 112 may be coupled to the first gear drive mechanism 110a which may be coupled to the first torque tube 104a. The rotational force from the motor 112 may cause the first gear drive mechanism 110a to rotate the first torque tube 104a thereby causing the first PV modules at the first solar tracker row 102a to rotate. The first driveline assembly 108a may be coupled at one end to the motor 112 and at another end to the second solar tracker row 102b. The first driveline assembly 108a may transmit the rotational force exerted by the motor 112 to the second gear drive mechanism 110b, which may cause the second gear drive mechanism 110b to rotate the second torque tube 104b thereby causing the second PV modules to rotate.

The second driveline assembly 108b may be coupled at one end to the second solar tracker row 102b and at another end to the third solar tracker row 102c. For example, the second driveline assembly 108b may be coupled to the second gear drive mechanism 110b at one end and to a third gear drive mechanism 110c at another end. The second driveline assembly 108b may transmit the rotational force exerted by the motor 112 from the second gear drive mechanism 110b to the third gear drive mechanism 110c, which may cause the third gear drive mechanism 110c to rotate the third torque tube 104c thereby causing the third PV modules to rotate.

The rotational force may be further transmitted to additional solar tracker rows in the solar tracker system 100 in a similar manner as that described above. For example, a third driveline assembly 108c may transmit the rotational force from the third gear drive mechanism 110c to a fourth gear drive mechanism 110d at a fourth solar tracker row 102d, and/or a fourth driveline assembly 108d may transmit the rotational force from the fourth gear drive mechanism 110d to a fifth gear drive mechanism 110e at a fifth solar tracker row 102e. Additionally, the rotational force may be transmitted in the opposite direction from the motor 112. For example, the motor 112 may be coupled to the first gear drive mechanism 110a, and the first gear drive mechanism 110a may transmit the rotational force from the motor 112 to a fifth driveline assembly 108e coupling the first solar tracker row 102a to the sixth solar tracker row 102f. The fifth driveline assembly 108e may transmit the rotational force from the first gear drive mechanism 110a to a sixth gear drive mechanism 110g, which may cause the sixth gear drive mechanism 110g to rotate a sixth torque tube 104g causing one or more sixth PV modules to rotate. The rotational force from the motor 112 may be transmitted further in this direction to additional solar tracker rows 102 with additional driveline assemblies 108.

Modifications, additions, or omissions may be made to the solar tracker system 100 without departing from the scope of the present disclosure. For example, the solar tracker system 100 may have more or less solar tracker rows 102 depending on the configuration of the solar tracker system 100. As illustrated, the first solar tracker row 102a having the motor 112 may be a middle row, but, in some embodiments, the first solar tracker row 102a may be an end row. Furthermore, in some embodiments, multiple motors 112 may be utilized. For example, a first motor may transmit a rotational force to the first solar tracker row 102a, the second solar tracker row 102b, the third solar tracker row 102c, the fourth solar tracker row 102d, and the fifth solar tracker row 102e, and a second motor may transmit a rotational force to the sixth solar tracker row 102f, a seventh solar tracker row 102g, and the eighth solar tracker row 102h.

Furthermore, the components illustrated in and described with reference to FIG. 1, may be similar to, have similar features as, or perform similar functions as similarly named components described throughout this disclosure. For example, the driveline of the driveline assemblies 108 may be similar to the drivelines described in FIGS. 2–8B.

FIG. 2 illustrates a partial view of an example solar tracker system 200. The solar tracker system 200 may include a first solar tracker row 202a and a second solar tracker row 202b. The first solar tracker row 202a may include one or more first PV modules 216a, a first torque tube (not shown), and a motor 212. The first torque tube may be coupled to the first PV modules 216a such that rotation of the first torque tube rotates the first PV modules 216a. The second solar tracker row 202b may include one or more second PV modules 216b and a second torque tube (not shown). The second torque tube may be coupled to the second PV modules 216b such that rotation of the second torque tube rotates the second PV modules 216b. The solar tracker system 200 may also include one or more support columns (or piles) 206. The support columns 206 may be driven into the ground and may provide vertical support for the PV modules 216 and the torque tubes. The torque tubes may provide horizontal support for the PV modules 216.

The motor 212 may exert a rotational force that may cause the torque tubes at the solar tracker rows 202 to rotate. For example, the motor 212 may exert a rotational force that rotates the first torque tube at the first solar tracker row 202a. As described previously, in some embodiments, the motor 212 may be an electric motor such as an AC motor or a DC motor.

In some embodiments, the solar tracker rows 202 may include a gear drive mechanism 210. For example, the first solar tracker row 202amay include a first gear drive mechanism 210a coupled to the first torque tube, and the second solar tracker row may include a second gear drive mechanism 210b coupled to the second torque tube. In some embodiments, the first gear drive mechanism 210a and the second gear drive mechanism 210b may be slew drives including a worm gear. In some embodiments, the gear drive mechanisms 210 may be a slew drive, a worm gear drive, a bevel gear drive, a planetary gear drive, a cycloidal drive, a helical gear drive, a harmonic drive, a spur gear drive, a rack and pinion drive, a combination of gear drive mechanisms, or any other suitable gear drive mechanism.

The solar tracker system 200 may also include one or more driveline assemblies 208 that may couple one solar tracker row 202 to another solar tracker row 202. For example, a first driveline assembly 208a may couple the first solar tracker row 202a to the second solar tracker row 202b. The first driveline assembly 208a may include a first driveline 209a that may transmit the rotational force from the motor 212 at the first solar tracker row 202a to the second torque tube at the second solar tracker row 202b. The first driveline assembly 208amay also include a first U-joint 214a coupling the first driveline 209a to the motor 212. The first U-joint 214a may transmit the rotational force from the motor 212 to the first driveline 209a.

The first driveline assembly 208a may further include a second U-joint (not shown) coupling the first driveline 209a to the second solar tracker row 202b. In some embodiments, the second U-joint may couple the first driveline 209a to the second gear drive mechanism 210b at the second solar tracker row 202b. In these and other embodiments, the second U-joint may transmit the rotational force to the second gear drive mechanism 210b such that the second gear drive mechanism 210b causes the second torque tube to rotate.

In some embodiments, the solar tracker system 200 may include a second driveline assembly 208b, and the second driveline assembly 208b may couple the second solar tracker row 202b to a third solar tracker row (not shown). The third solar tracker row may include one or more third PV modules and a third torque tube coupled to the third PV modules such that rotation of the third torque tube rotates the third PV modules. The second driveline assembly 208b may include a second driveline 209b that may transmit the rotational force from the first driveline 209a to the third torque tube. For example, the first driveline 209a may transmit the rotational force to the second gear drive mechanism 210b which may transmit the rotational force to the second driveline 209b, which may further transmit the rotational force to the third torque tube. The second driveline assembly 208b may include a third U-joint 214c and a fourth U-joint 214d. The third U-joint 214c may couple the second driveline 209b to the second solar tracker row 202b. For example, the third U-joint 214c may be coupled to the second gear drive mechanism 210b. The fourth U-joint 214d may couple the second driveline 209b to the third solar tracker row and may transmit the rotational force from the second driveline 209b to the third torque tube. For example, the fourth U-joint 214d may couple the second driveline 209b to a third gear drive mechanism at the third solar tracker row.

In some embodiments, the drivelines 209 may be between about 5 feet and about 40 feet in length. In some embodiments, the drivelines 209 may be substantially the same length such that the solar tracker rows 202 may be separated by equivalent or nearly equivalent distances. For example, the first driveline 209a and the second driveline 209b may be both about 25 feet in length. In some embodiments, the drivelines 209 may have different lengths such that the solar tracker rows 202 may be separated by varying distances. For example, the first driveline 209a may be about 20 feet long and the second driveline 209b may be about 25 feet long.

The drivelines 209 may each include an inner surface and an outer surface. The inner surface and outer surface of each driveline 209 may define a thickness. In some embodiments, the thickness may be uniform. In some embodiments, the thickness may be nonuniform. In some embodiments, the thickness of each driveline 209 may be the same. For example, the first driveline 209a and the second driveline 209b may have the same thickness. In some embodiments, the thickness of each driveline 209 may be different. For example, the thickness of the second driveline 209b may be less than the thickness of the first driveline 209a. Thus, drivelines 209 that may be farther away from the motor 212 and may experience less rotational force, may not be as thick as drivelines 209 that are closer to the motor 212. As a result, less material may be utilized in the solar tracker system 200.

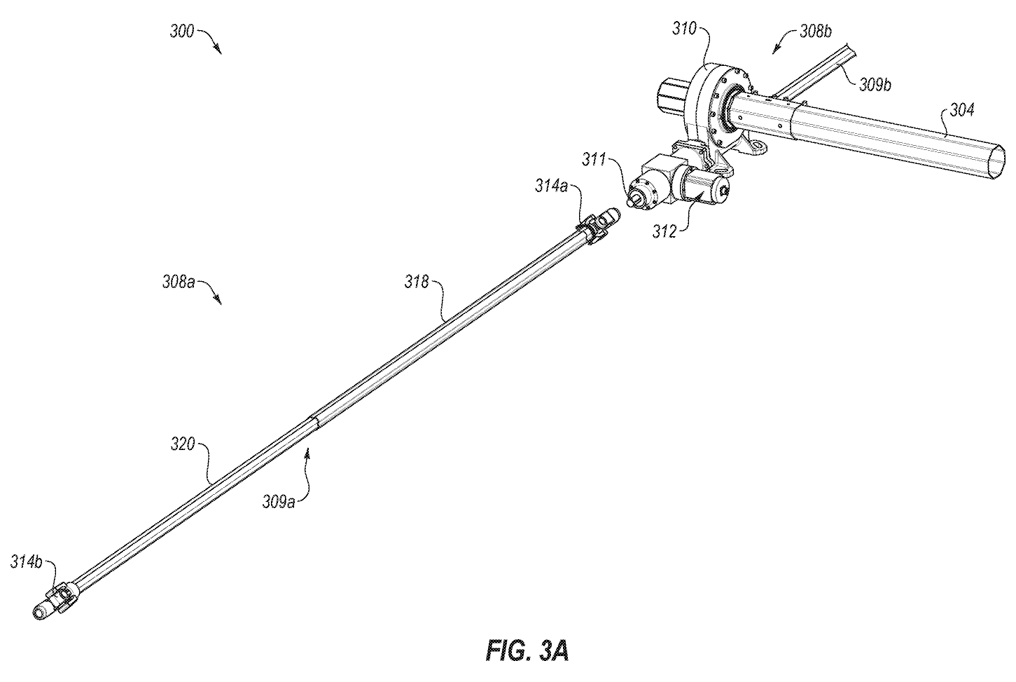

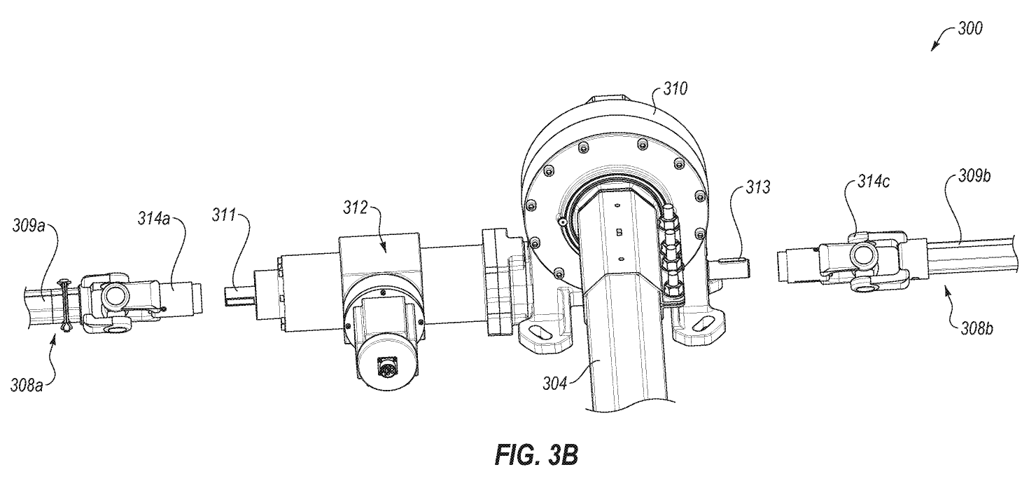

The drivelines 209 may further include four lobes defined by portions of the inner surface and outer surface. The four lobes may be arranged symmetrically about a central axis centered in and extending through the drivelines 209. The drivelines 209 may further include four recesses defined by portions of the inner and outer surfaces. The four recesses may be arranged symmetrically about the central axis, and each recess may separate a lobe of the four lobes from another lobe of the four lobes. The cross-sectional geometry of the drivelines 209 may be defined, at least in part, by the four lobes and the four recesses, and the cross-sectional geometry may increase the torque capacity of the drivelines 209 such that additional solar tracker rows 202 may be added to the solar tracker system 200 and/or the length of the drivelines 209 may be increased such that the solar tracker rows 202 may be spaced further apart. The drivelines 209 are explained in more detail with reference to FIGS. 3A–8B.

In an example operation of the solar tracker system 200, the motor 212 at the first solar tracker row 202a may exert a rotational force. The first gear drive mechanism 210a may be coupled to the first torque tube at the first solar tracker row 202a and the first gear drive mechanism 210a may transmit the rotational force exerted by the motor 212 to the first torque tube such that the first PV modules 216a may be rotated to track the position of the Sun. The first U-joint 214a may couple the first driveline 209a to the motor 212 and may transmit the rotational force from the motor 212 to the first driveline 209a, which may rotate the first U-joint 214a and the first driveline 209a. The first driveline 209a may transmit the rotational force from the motor 212 to the second torque tube at the second solar tracker row 202b. For example, the first driveline 209a may be coupled to a second U-joint, which may couple the first driveline 209a to the second solar tracker row 202b, and the second U-joint may transmit the rotational force from the first driveline 209a to the second torque tube. For instance, the second U-joint may be coupled to the second gear drive mechanism 210b, which may be coupled to the second torque tube such that rotation of the second U-joint causes the second gear drive mechanism 210b to rotate the second torque tube. As a result, the second PV modules 216b may be rotated.

In some embodiments, the rotational force from the motor 212 may be transmitted further in the same direction. For example, the third U-joint 214c may couple the second driveline 209b to the second solar tracker row 202b. The second gear drive mechanism 210b may transmit the rotational force to the third U-joint 214c causing the third U-joint 214c to rotate, which may transmit the rotational force to the second driveline 209b causing the second driveline 209b to rotate. The second driveline 209b may transmit the rotational force to a fourth U-joint 214d coupling the second driveline 209b to the third solar tracker row (not shown), which may cause the fourth U-joint 214d to rotate. The fourth U-joint 214d may transmit the rotational force from the second driveline 209b to the third torque tube at the third solar tracker row via, for example, a third gear drive mechanism. Additional solar tracker rows 202 may be implemented in the same direction, and the rotational force may be transmitted to the additional solar tracker rows 202 using similar components.

In some embodiments, the rotational force from the motor 212 may be transmitted in an opposite direction from the first solar tracker row 202a. For example, the motor 212 may be included at a middle solar tracker row as illustrated in FIG. 2. In these and other embodiments, the rotational force may be transmitted in one direction towards one or more solar tracker rows 202 and in another direction towards one or more other solar tracker rows 202. For example, the first solar tracker row 202a may be coupled to a fourth solar tracker row (not shown) via a third driveline assembly 208c. The fourth solar tracker row may be on an opposite side of the first solar tracker row 202a as the second solar tracker row 202b and the third solar tracker row. The third driveline assembly 208c may transmit the rotational force from the motor 212 to the fourth solar tracker row. The third driveline assembly 208c may include a fifth U-joint (not shown), a sixth U-joint (not shown), and a third driveline 209c. For example, a third driveline 209c may be coupled to the first solar tracker row 202a via the fifth U-joint. For instance, the fifth U-joint may couple the third driveline 209c to the first gear drive mechanism 210a, and the first gear drive mechanism 210a may transmit the rotational force from the motor 212 to the fifth U-joint, which may transmit

the rotational force to the third driveline 209c. The third driveline 209c may be coupled to the fourth solar tracker row via the sixth U-joint, and the third driveline 209c may transmit the rotational force to the sixth U-joint, which may transmit the rotational force to a fourth torque tube at the fourth solar tracker row. Thus, the third driveline assembly 208c may cause the fourth torque tube to rotate and a third set of PV modules to rotate at the fourth solar tracker row. Additional solar tracker rows 202 may be implemented in the same direction, and the rotational force may be transmitted to the additional solar tracker rows 202 using similar components.

Modifications, additions, or omissions may be made to the solar tracker system 200 without departing from the scope of the present disclosure. For example, the solar tracker system 200 may have more or less solar tracker rows 202 depending on the configuration of the solar tracker system 200. As illustrated, the first solar tracker row 202a having the motor 212 may be a middle row, but, in some embodiments, the first solar tracker row 202a may be an end row. In some embodiments, multiple motors 212 may be utilized.

In some embodiments, the drivelines 209 may be telescopic, and each of the drivelines 209 may have a first section and a second section that are coupled together. In these and other embodiments, the first section may be coupled to one of the U-joints 214 of the driveline assembly 208, and the second section may be coupled to the other U-joint of the driveline assembly 208. Furthermore, the components illustrated in and described with reference to FIG. 2 may be similar to, have similar features as, or perform similar functions as similarly named components described throughout this disclosure.

FIG. 3A and FIG. 3B respectively illustrate a perspective exploded view of a solar tracker system 300, and a top exploded view of the solar tracker system 300. The solar tracker system 300 may include one or more driveline assemblies 308 and a motor 312. The motor 312 may be included at a first solar tracker row and may exert a rotational force that may be transmitted to other solar tracker rows utilizing the one or more driveline assemblies 308. The first solar tracker row may also include a gear drive mechanism 310 and a torque tube 304 coupled to one or more first PV modules (not shown) such that rotation of the torque tube 304 causes the first PV modules to rotate.

The motor 312 may be coupled on a first side to a first driveline assembly 308a. For example, the motor 312 may include a first driveshaft 311, which may be coupled to the first driveline assembly 308a. The rotational force of the motor 312 may rotate the first driveshaft 311, which may rotate the first driveline assembly 308a.

The first driveline assembly 308a may include a first U-joint 314a, a second U-joint 314b, and a first driveline 309a. The first U-joint 314a may couple one end of the first driveline 309a to the first solar tracker row. For example, the first U-joint 314a may couple one end of the first driveline 309a to the first driveshaft 311 of the motor 312. The first U-joint 314a may transmit the rotational force from the motor 312 to the first driveline 309. For example, the rotational force from the motor 312 may rotate the first driveshaft 311, which may cause the first U-joint 314a to rotate thereby causing the first driveline 309a to rotate.

The first driveline 309a may be coupled to the second U-joint 314b at an end of the first driveline 309a opposite of the first U-joint 314a. The second U-joint 314b may be coupled to the first driveline 309a on one side and coupled on a second side to a second solar tracker row (not shown). In some embodiments, the second U-joint 314b may be coupled to a second driveshaft at the second solar tracker row. In some embodiments, the second driveshaft may be included in a second gear drive mechanism (not shown).

The second U-joint 314b may be configured to transmit the rotational force from the first driveline 309 to the second solar tracker row. For example, rotation of the first driveline 309 may cause the second U-joint 314b to rotate, and the second U-joint 314b may rotate the driveshaft of the second gear drive mechanism at the second solar tracker row, which may cause a second torque tube at the second solar tracker row to rotate. As a result, one or more PV modules (not shown) at the second solar tracker row may rotate.

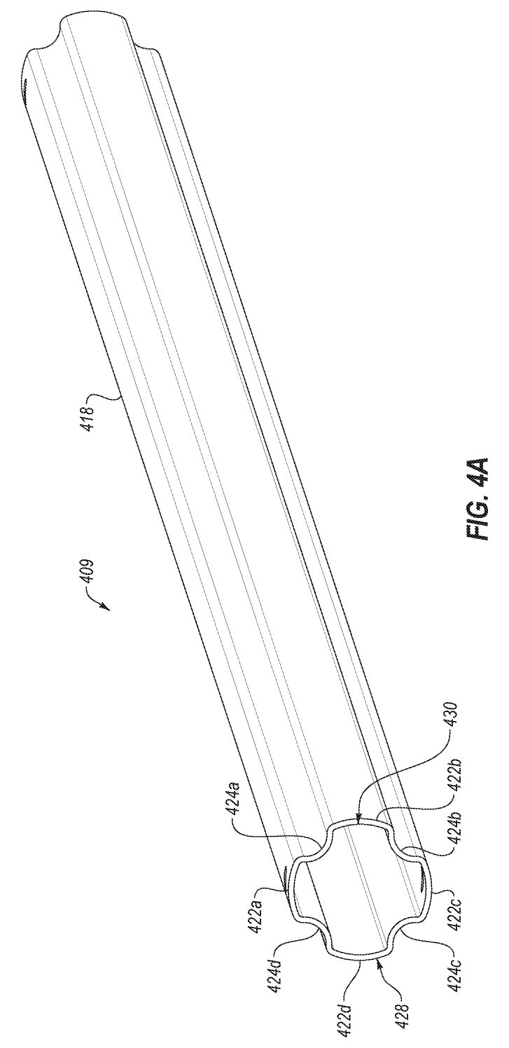

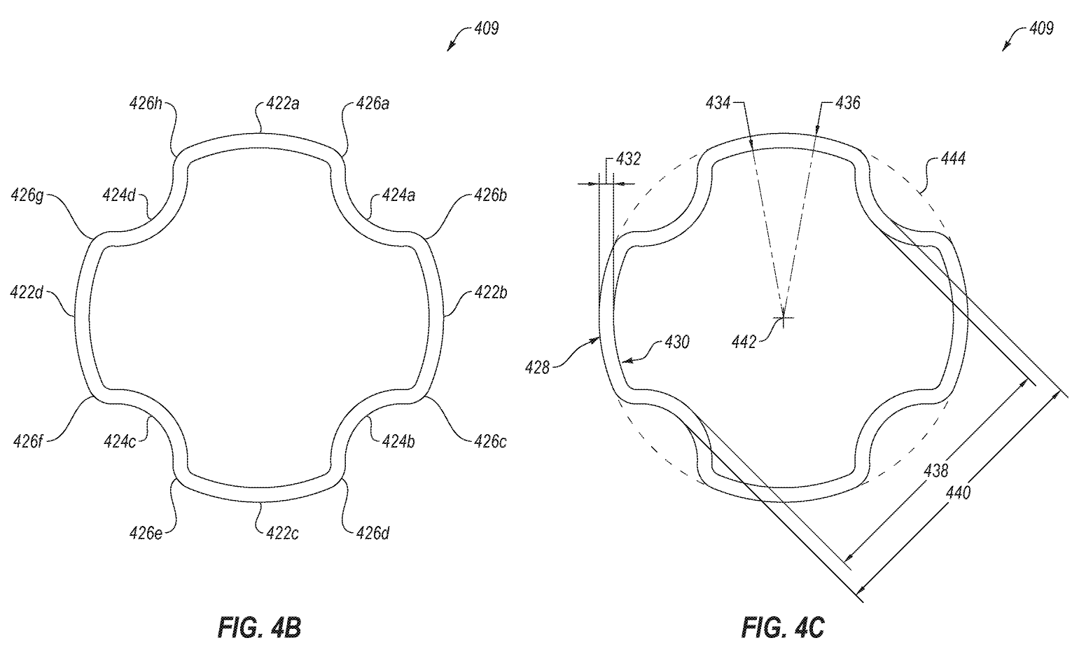

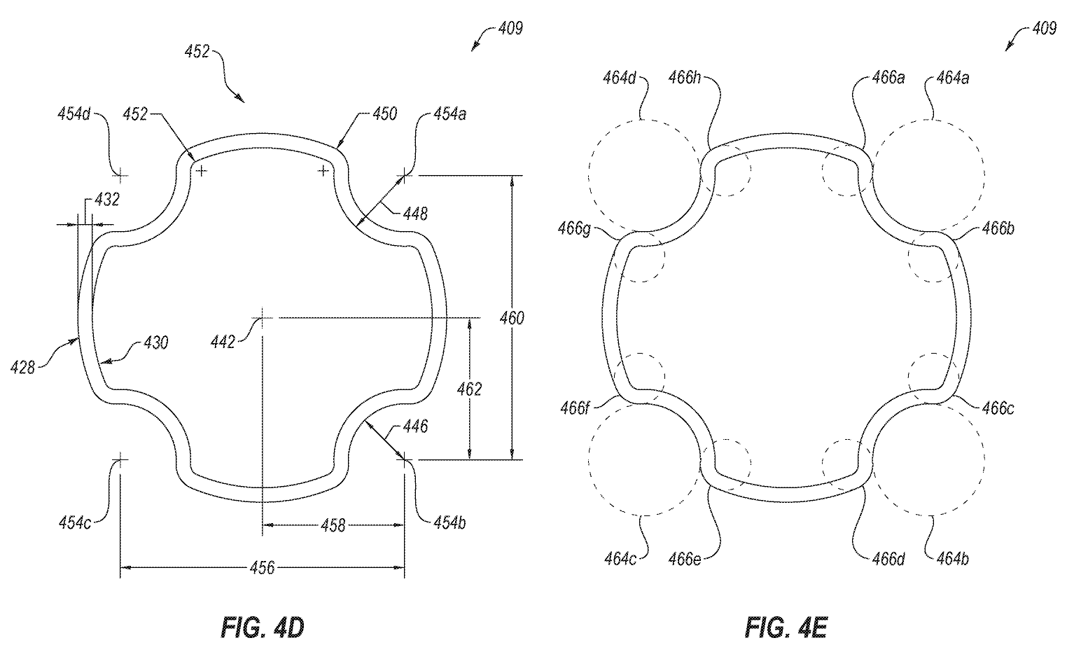

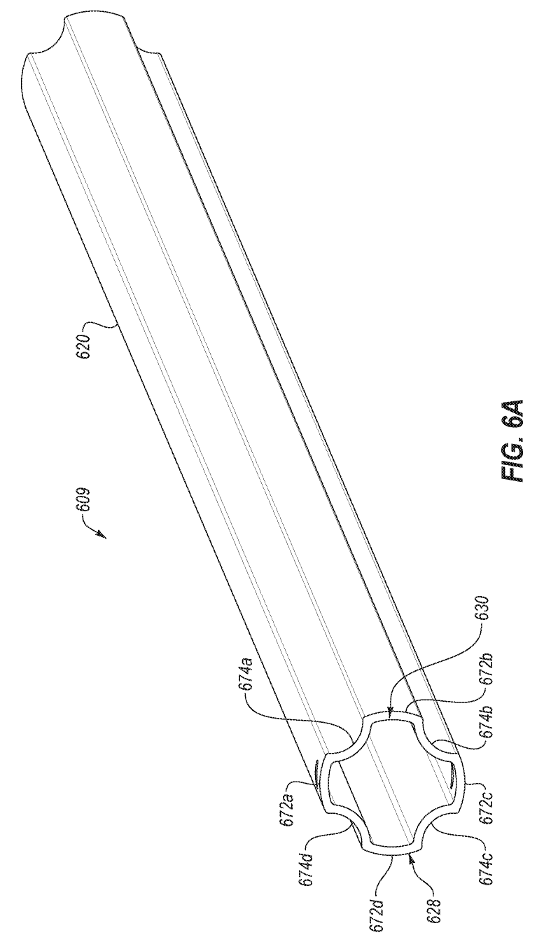

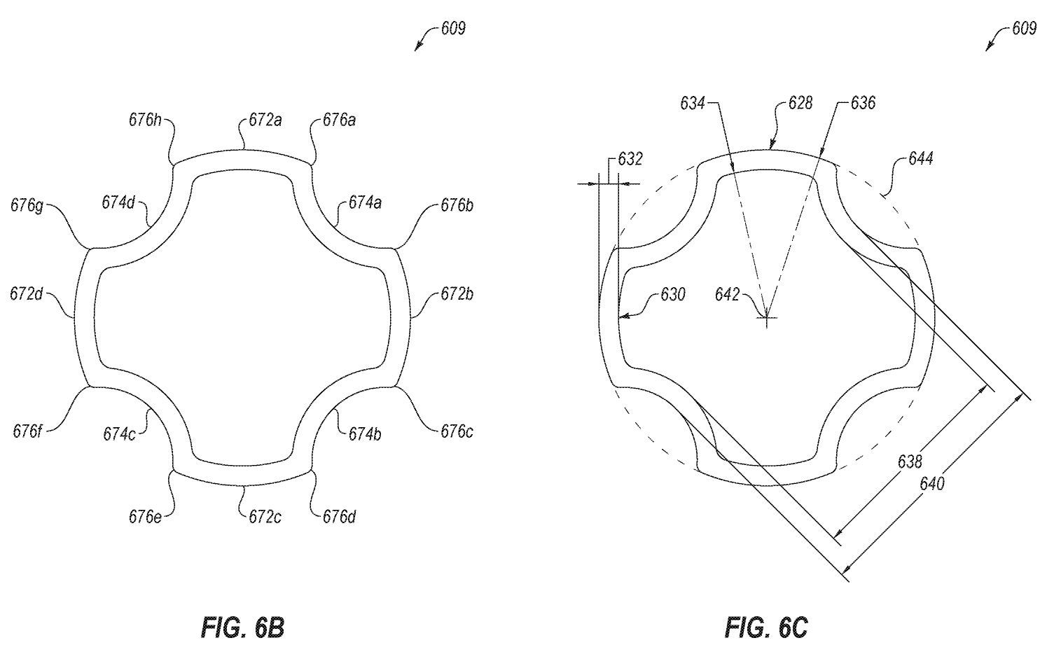

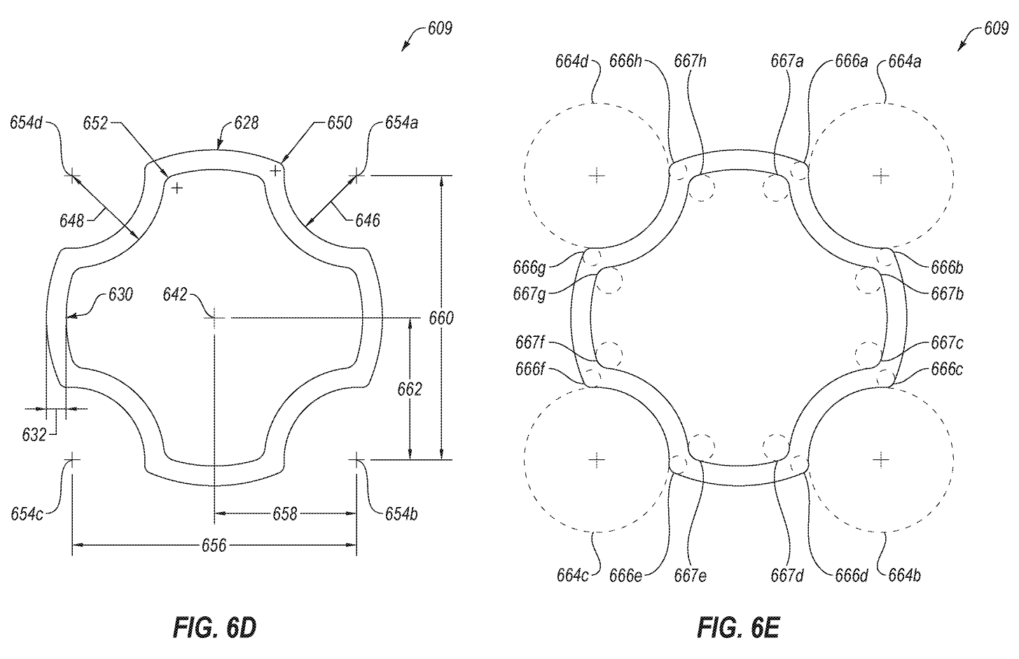

In some embodiments, the first driveline 309 may include one or more sections. For example, the first driveline 309 may include a first section 318 coupled with a second section 320. As illustrated in FIG. 3A, in some embodiments, the first section 318 may be a female component configured to receive the second section 320, which may be a male component. For example, the first section 318 may have a cross-sectional geometry defined, at least partially, by an inner surface, an outer surface, four lobes arranged symmetrically about a central axis, and four recesses arranged symmetrically about the central axis as described in more detail with reference to FIGS. 4A–4E. The second section 320 may have a corresponding cross-sectional geometry with four corresponding lobes and four corresponding recesses arranged symmetrically about the central axis such that at least a portion of the second section fits within the first section 318. The corresponding cross-sectional geometry of the second section 320 is described in more detail with reference to FIGS. 6A–6E. In some embodiments, the second section 320 may be a female component configured to receive the first section 318, which may be a male component.

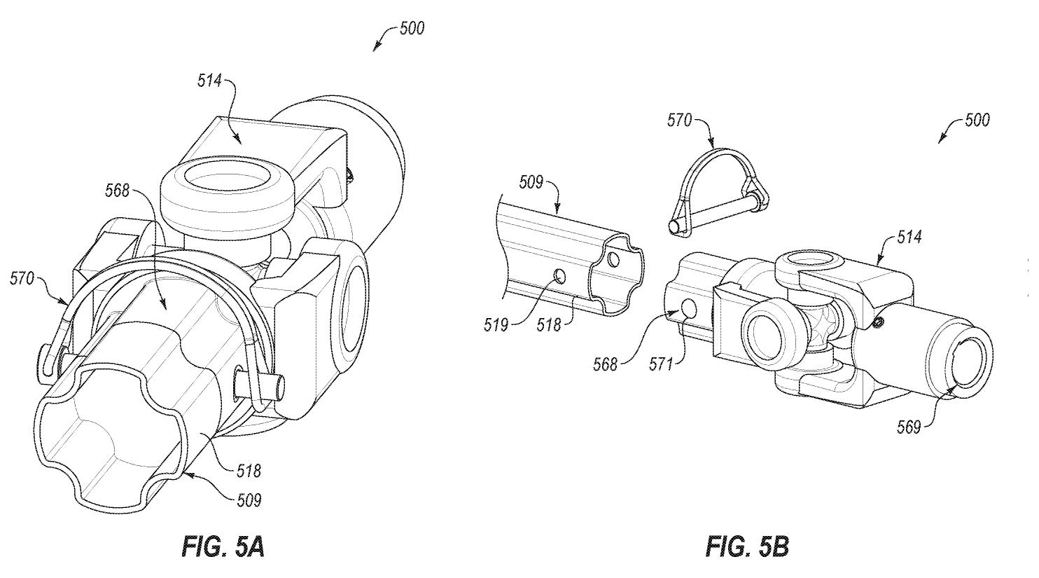

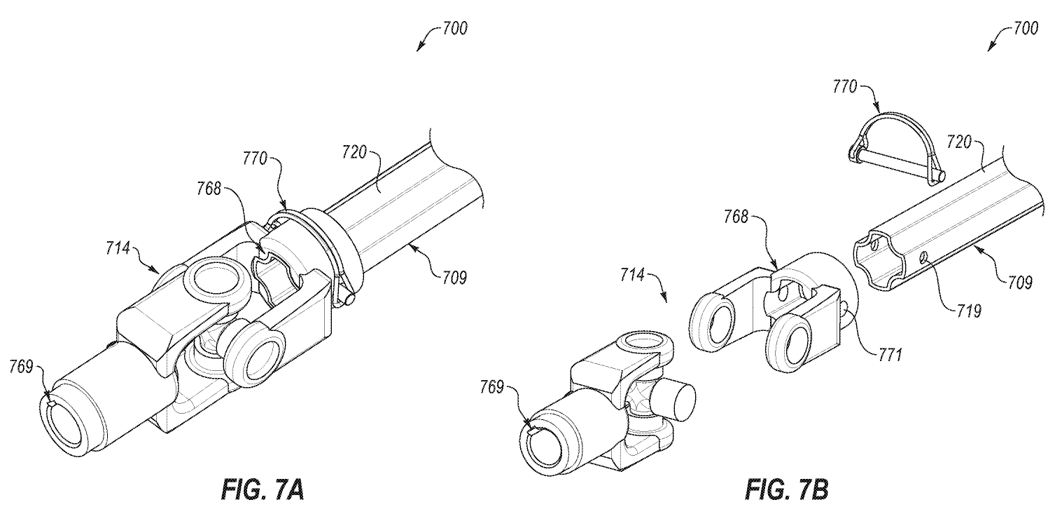

In some embodiments, the first section 318 may be coupled to the first U-joint 314a, and the second section 320 may be coupled to the second U-joint 314b. This is described in more detail with reference to FIGS. 5A and 5B and FIGS. 7A and 7B.

In some embodiments, the first section 318 of the first driveline 309a may be coupled to the second section 320 such that rotation of the first section 318 may be transmitted to the second section 320. Thus, the rotational force may be transmitted from the first section 318 to the second section 320.

The motor 312 may be coupled on a second side to the gear drive mechanism 310. As illustrated in FIGS. 3A and 3B, the gear drive mechanism 310 may be a slew drive. The rotational force of the motor 312 may be transmitted to the gear drive mechanism 310. The gear drive mechanism 310 may transmit the rotational force from the motor 312 to the torque tube 304 causing the torque tube 304 to rotate, which may in turn cause the one or more PV modules (not shown) coupled to the torque tube to rotate.

As illustrated in FIG. 3B, the gear drive mechanism 310 may include a third driveshaft 313. A second driveline assembly 308b may be coupled to the gear drive mechanism 310. For example, the second driveline assembly 308b may be coupled to the third driveshaft 313. The second driveline assembly 308b may include a third U-joint 314c, a fourth U-joint (not shown), and a second driveline 309b. The second driveline assembly 308b may be similar to and perform similar functions as the first driveline assembly 308a. The third U-joint 314c may be coupled on a first side to the second driveline 309b and coupled on a second side to the first solar tracker row. For example, the third U-joint 314c may be coupled to the third driveshaft 313 of the gear drive mechanism 310. The rotational force exerted by the motor 312 may be transmitted from the gear drive mechanism 310 to the third U-joint 314c, which may transmit the rotational force to the second driveline 309b. For example, the rotational force exerted by the motor 312 may cause the third driveshaft 313 to rotate, which may rotate the third U-joint 314c, which may cause the second driveline 309b to rotate. The second driveline 309b may transmit the rotational force to the fourth U-joint, which may transmit the rotational force to a third torque tube at a third solar tracker row. For example, the fourth U-joint may be coupled to a third gear drive mechanism at the third solar tracker row, and rotation of the fourth U-joint may cause the third gear drive mechanism to rotate the third torque tube thereby rotating one or more PV modules at the third solar tracker row.

Modifications, additions, or omissions may be made to the solar tracker system 300 without departing from the scope of the present disclosure. For example, the first section 318 or the second section 320 may be omitted such that the first section 318 or the second section 320 may make up the entirety of the length of the driveline 309. In some embodiments, one or more ends of the drivelines 309 may be directly connected to the solar tracker rows and any of the U-joints 314 may be omitted. For example, the first driveline 309a may be directly connected to the first driveshaft 311 of the motor 312 and the first U-joint 314a may be omitted. Furthermore, in some embodiments, the first section 318 may be configured as a male component and the second section 320 may be configured as a female component such that the second section 320 may receive the first section 318.

Additionally, the components illustrated in and described with reference to FIG. 3, may be similar to, have similar features as, or perform similar functions as similarly named components described throughout this disclosure.

FIG. 4A illustrates an example driveline 409 that may be utilized in an example solar tracker system such as the solar tracker systems 100, 200, or 300 respectively described with reference to FIG. 1, FIG. 2, and FIGS. 3A and 3B. For example, the driveline 409 may be utilized in any of the driveline assemblies described throughout this disclosure. FIGS. 4B–4E illustrate various cross-sectional views of the driveline 409 showing various example dimensions of the driveline 409.

As illustrated in FIG. 4A, the driveline 409 may include an outer surface 428 and an inner surface 430. The driveline 409 may further include four lobes 422 defined by portions of the outer surface 428 and the inner surface 430. For example, the driveline 409 may include a first lobe 422a, a second lobe 422b, a third lobe 422c, and a fourth lobe 422d all defined by different portions of the outer surface 428 and the inner surface 430. The driveline 409 may also include four recesses 424 defined by portions of the outer surface 428 and the inner surface 430. For example, the driveline 409 may include a first recess 424a, a second recess 424b, a third recess 424c, and a fourth recess 424d all defined by different portions of the outer surface 428 and the inner surface 430. Each recess 424 may separate a lobe 422 of the four lobes 422 from another lobe 422 of the four lobes 422. For example, the first recess 424a may separate the first lobe 422a from the second lobe 422b, the second recess 424b may separate the second lobe 422b from the third lobe 422c, the third recess 424c may separate the third lobe 422c from the fourth lobe 422d, and the fourth recess 424d may separate the fourth lobe 422d from the first lobe 422a.

In some embodiments, the driveline 409 may be between about 5 feet and about 40 feet in length. In some embodiments, the driveline 409 may be a first section 418 of a driveline 409 that may be coupled to a second section of the driveline 409. For example, the first section 418 may be coupled with the driveline described with reference to FIGS. 6A–6E, which may be a second section. In some embodiments, the outer surface 428, the inner surface 430, the lobes 422, and the recesses 424 may at least partially define a cross-sectional geometry of the first section 418 of the driveline 409, and the second section of the driveline 409 may have a corresponding cross-sectional geometry to the cross-sectional geometry of the first section 418. For example, the second section may include four corresponding lobes and four corresponding recesses arranged symmetrically about a central axis centered in and extending through the driveline such that at least a portion of the second section fits within the first section 418 and rotation of either section transmits rotation to the other section.

As illustrated in FIGS. 4B and 4C, each lobe 422 and/or each recess 424 of the driveline 409 may be arranged symmetrically about a central axis 442 centered in and extending through the driveline 409. In some embodiments, each lobe 422 may be convex relative to the central axis 442. In some embodiments, each recess 424 may be concave relative to the central axis 442.

In these and other embodiments, the driveline 409 may include one or more interfaces 426. Each interface 426 may transition a recess 424 of the four recesses 424 into a lobe 422 of the four lobes 422. For example, each lobe 422 may be convex relative to the central axis 442, each recess 424 may be concave relative to the central axis 442, and each interface 426 may blend a curvature of a recess 424 into a curvature of an adjacent lobe 422. For instance, a first interface 426a may blend a curvature of the first recess 424a into a curvature of the first lobe 422a, and a second interface 426b may blend a curvature of the first recess 424a into a curvature of the second lobe 422b.

As illustrated in FIG. 4C, the outer surface 428 and the inner surface 430 of the driveline 409 may define a thickness 432 of the driveline 409. In some embodiments, the thickness 432 may be uniform. In some embodiments, the thickness 432 may be nonuniform. In some embodiments, the thickness 432 of the driveline 409 at each interface 426 of the one or more interfaces 426 may be greater than the thickness 432 of the driveline 409 at the lobes 422 and/or the recesses 424. In some embodiments, the thickness 432 of the driveline 409 may be between about 1 millimeter and about 5 millimeters. For instance, the thickness 432 of the driveline 409 may be about 2.2 millimeters.

In some embodiments, a first distance from the central axis 442 to the portion of the outer surface 428 defining each lobe 422 may be between about 25 millimeters and about 35 millimeters. For example, the outer surface 428 of each lobe 422 may define a portion of a circle 444, which may be centered with the central axis 442, and the distance from the central axis 442 to the outer surface 428 may be a radius 436 of the circle 444 that may be between about 25 millimeters and about 35 millimeters. For instance, the radius 436 of the circle 444 may be about 28 millimeters.

In some embodiments, the driveline 409 may be the first section 418 of the driveline 409, and the radius 436 may be between about 1 millimeter and about 5 millimeters greater than a similar radius of the second section. For example, the driveline 409 may be the first section 418 and the radius 436 may be about 28 millimeters, and the driveline 409 may be coupled to a second section which may have a radius of about 25.5 millimeters.

In some embodiments, a second distance from the central axis 442 to the portion of the inner surface 430 defining the lobe 422 may be the difference between the first distance from the central axis 442 to the portion of the outer surface 428 defining each lobe 422 and the thickness 432 at each lobe 422. For example, the inner surface 430 of each lobe 422 may define a portion of a second circle (not shown) with a radius 434 that may be the difference between the radius 436 of the circle 444 and the thickness 432. For instance, the radius 436 may be about 28 millimeters, the thickness 432 may be about 2.2 millimeters, and radius 434 may be about 25.8 millimeters.

In some embodiments, a minimum distance 438 between two points on the inner surface 430 may be between about 30 millimeters and about 45 millimeters. For example, the minimum distance 438 between the portion of the inner surface 430 defining the first recess 424a and the portion of the inner surface 430 defining the third recess 424c may be between about 30 millimeters and about 45 millimeters. For instance, the minimum distance 438 between two points on the inner surface 430 may be about 39.6 millimeters. In some embodiments, a minimum distance 440 between two points on the outer surface 428 may be between about 35 millimeters and about 50 millimeters. For example, the minimum distance 440 between the portion of the outer surface 428 defining the first recess 424a and the portion of the outer surface 428 defining the third recess 424c may be between about 35 millimeters and about 50 millimeters. In some embodiments, the thickness 432 may be uniform, and the minimum distance 440 between two points on the outer surface 428 may be the sum of the minimum distance 438 between two points on the inner surface 430 and twice the thickness 432. For example, the minimum distance 438 between two points on the inner surface 430 may be about 39.6 millimeters, the thickness 432 may be about 2.2 millimeters, and the minimum distance 440 between two points on the outer surface 428 may be about 44 millimeters.

In some embodiments, the driveline 409 may be the first section 418 of the driveline 409, and the minimum distance 438 between two points on the inner surface 430 and/or the minimum distance 440 between two points on the outer surface 428 may be between about 1 millimeter and about 10 millimeters greater than those distances of the second section. For example, the driveline 409 may be the first section 418, and the minimum distance 438 between two points on the inner surface 430 may be about 39.6 millimeters, and the driveline 409 may be coupled to a second section, which may have a minimum distance between two points on the inner surface of the second section of about 33 millimeters.

In some embodiments, and as illustrated with respect to FIG. 4D, each recess 424 may be concave relative to the central axis 442 and convex relative to an external axis 454. For example, each recess 424 may be concave relative to the central axis 442, the first recess 424a may be convex relative to a first external axis 454a, the second recess 424b may be convex relative to a second external axis 454b, the third recess 424c may be convex relative to a third external axis 454c, and the fourth recess 424d may be convex relative to a fourth external axis 454d.

As illustrated in FIG. 4D and FIG. 4E, in some embodiments, a distance 446 from each external axis 454 to the portion of the outer surface 428 defining each recess 424 may be between about 5 millimeters and about 15 millimeters. For example, the distance 446 from each external axis 454 to the portion of the outer surface defining each recess 424 may be about 8.5 millimeters. In some embodiments, each recess 424 may define a portion of a circle 464 centered with an external axis of the external axes 454, and the distance 446 may be a radius of the circle 464. For example, the portion of the outer surface 428 defining the first recess 424a may define a portion of a circle 464a centered with the first external axis 454a, and the distance 446 may be a radius of the circle 464a between about 5 millimeters and about 15 millimeters. In some embodiments, a distance 448 from each external axis 454 to the portion of the inner surface 430 defining each recess 424 may be the sum of the distance 446 and the thickness 432 at each recess 424. For example, the distance 446 from each external axis 454 to the portion of the outer surface 428 defining each recess 424 may be about 8.5 millimeters, the thickness 432 may be about 2.2 millimeters, and the distance 448 from each external axis 454 to the portion of the inner surface 430 defining each recess 424 may be about 10.7 millimeters.

In some embodiments, a horizontal distance 456 between each external axis 454 may be between about 30 millimeters and about 60 millimeters. For example, the horizontal distance 456 between the external axes 454 may be about 43.1 millimeters. In some embodiments, the horizontal distance 458 between the central axis 442 and the external axes 454 may be between about 15 millimeters and about 30 millimeters. For example, the horizontal distance 458 between the central axis 442 and the external axes 454 may be about 21.6 millimeters. In some embodiments, the vertical distance 460 between the external axes 454 may be between about 30 millimeters and about 60 millimeters. For example, the vertical distance 460 between the external axes 454 may be about 43.1 millimeters. In some embodiments, the vertical distance 462 between the central axis 442 and the external axes 454 may be between about 15 millimeters and about 30 millimeters. For example, the vertical distance 462 between the central axis 442 and the external axes 454 may be about 21.6 millimeters.

In some embodiments, and as illustrated with respect to FIG. 4D and FIG. 4E, each interface 426 may have an outer radius 450 and an inner radius 452. In some embodiments, the outer radius 450 may be between about 1 millimeter and about 6 millimeters. For example, each interface 426 may have an outer radius 450 between about 1 millimeter and about 6 millimeters from the center of a circle 466 to the portion of the outer surface 428 defining the interface 426. For instance, the outer radius 450 may be around 4 millimeters from the center of the circle 466 to the portion of the outer surface 428 at each interface 426. In some embodiments, the inner radius 452 may be between about 1 millimeter and about 6 millimeters. In some embodiments, the inner radius 452 may be the difference between the outer radius 450 and the thickness 432. For instance, the outer radius 450 may be about 4 millimeters, the thickness may be about 2.2 millimeters, and the inner radius 452 may be about 1.8 millimeters.

Modifications, additions, or omissions may be made to the driveline 409 without departing from the scope of the present disclosure. For example, in some embodiments, the thickness 432 may be nonuniform. In some embodiments, the lobes 422, the recesses 424, and/or the interfaces 426 may not have a rounded shape. Furthermore, while both the lobes 422 and the recesses 424 are described as being symmetrically arranged about the central axis 442, it will be appreciated that manufacturing of the driveline 409 may be within certain tolerances such that the lobes 422 and the recesses 424 may not be perfectly symmetrically arranged about the central axis 442. Moreover, in some embodiments, the lobes 422 and/or the recesses 424 may be asymmetrically arranged about the central axis 442. While reference is made to the driveline 409 being a first section 418, it will be appreciated that the driveline 409 need not have multiple sections, and that the driveline 409 may represent the configuration of the entire length of the driveline 409.

Additionally, specific examples of dimensions are provided for exemplary purposes, and the dimensions may be larger or smaller than those given depending on the particular implementation of the driveline 409. Furthermore, it will be appreciated that any specific examples of dimensions are subject to manufacturing tolerances and, for example, may deviate from those provided by plus or minus 0.5 millimeters.

FIG. 5A and FIG. 5B respectively illustrate a perspective view and an exploded view of a portion of a driveline assembly 500 that may be implemented in a solar tracker system such as the solar tracker systems 100, 200, or 300 described with reference to FIG. 1, FIG. 2, and FIGS. 3A and 3B. The driveline assembly 500 may include a driveline 509 and a U-joint 514.

A first side 568 of the U-joint 514 may be configured to be coupled to the driveline 509. As illustrated in FIGS. 5A and 5B, in some embodiments, the first side 568 of the U-joint 514 may be a male component, and the driveline 509 may be a female component configured to receive the first side 568 of the U-joint 514. In some embodiments, the driveline 509 may be a male component, and the first side 568 of the U-joint 514 may be a female component configured to receive the driveline 509. In some embodiments, the driveline 509 may have a first set of openings 519, and the U-joint 514 may have a second set of openings 571. In these and other embodiments, the first set of openings 519 of the driveline 509, and the second set of openings 571 of the U-joint 514 may be aligned when the U-joint 514 and the driveline 509 are coupled together. In these and other embodiments, a retention pin 570 may be inserted into the first set of openings 519 and the second set of openings 571 when the U-joint 514 and the driveline 509 are coupled to maintain the coupling between the U-joint 514 and the driveline 509 while the driveline 509 and the U-joint 514 rotate.

A second side 569 of the U-joint 514 may be configured to be coupled to a driveshaft. In some embodiments, the U-joint 514 may be configured to transmit a rotational force from the driveline 509 to a torque tube. For example, the second side 569 of the U-joint 514 may be coupled to the driveshaft of a gear drive mechanism, which may be coupled to a torque tube. The rotation of driveline 509 may cause the U-joint 514 to rotate, which in turn may cause the driveshaft of the gear drive mechanism to rotate thereby causing the torque tube to rotate. As a result, one or more PV modules coupled to the torque tube may be rotated. In some embodiments, the U-joint 514 may be configured to transmit a rotational force from the U-joint 514 to the driveline 509. For example, the second side 569 of the U-joint 514 may be coupled to a driveshaft of a motor or a driveshaft of a gear drive mechanism, and the U-joint 514 may transmit a rotational force from the motor or the gear drive mechanism to the driveline 509 causing the driveline 509 to rotate.

In some embodiments, the driveline 509 may include a first section 518 and a second section (not shown). For example, the first section 518 may be similar to the first section 418 described with reference to FIGS. 4A–4E and/or the first section 318 described with reference to FIG. 3. In these and other embodiments, the first side 568 of the U-joint 514 may be configured to receive the first section 518 of the driveline 509 and/or the first section 518 may be configured to receive the first side 568 of the U-joint 514. As illustrated in FIGS. 5A and 5B, the first section 518 may be a female component configured to receive the first side 568 of the U-joint 514, which may be a male component.

Modifications, additions, or omissions may be made to the driveline assembly 500 without departing from the scope of the present disclosure. For example, while a retention pin 570 is illustrated in FIGS. 5A and 5B as maintaining the coupling between the U-joint 514 and the driveline 509, it will be appreciated that other retention mechanisms may be utilized. For instance, a clamp, a friction-fit, a wedge fit, a rivet, an snap ring, a magnet, an adhesive, or other suitable retention mechanisms may be utilized. Furthermore, in some embodiments, the U-joint 514 may have male or female threads, the driveline 509 may have corresponding threads, and the U-joint 514 and the driveline 509 may be threadably coupled together. In these and other embodiments, the retention pin 570 may be omitted. Moreover, while the second side 569 of the U-joint 514 is illustrated as being configured to be coupled to a driveshaft, it will be appreciated that the second side 569 may be configured to be coupled to other components which may transmit a rotational force to the U-joint 514 or other components to which the U-joint 514 may transmit a rotational force.

Furthermore, the components illustrated in and described with reference to FIGS. 5A and 5B, may be similar to, have similar features as, or perform similar functions as similarly named components described throughout this disclosure. For example, the driveline 509 of the driveline assembly 500 may be similar to the drivelines described throughout this disclosure.

FIG. 6A illustrates an example driveline 609 that may be utilized in an example solar tracker system such as the solar tracker systems 100, 200, or 300 respectively described with reference to FIG. 1, FIG. 2, and FIGS. 3A and 3B. For example, the driveline 609 may be utilized in any of the driveline assemblies described throughout this disclosure. FIGS. 6B–6E illustrate various cross-sectional views of the driveline 609 showing various example dimensions of the driveline 609.

As illustrated in FIG. 6A, the driveline 609 may include an outer surface 628 and an inner surface 630. The driveline 609 may further include four lobes 672 defined by portions of the outer surface 628 and the inner surface 630. For example, the driveline 609 may include a first lobe 672a, a second lobe 672b, a third lobe 672c, and a fourth lobe 672d all defined by different portions of the outer surface 628 and the inner surface 630. The driveline 609 may also include four recesses 674 defined by portions of the outer surface 628 and the inner surface 630. For example, the driveline 609 may include a first recess 674a, a second recess 674b, a third recess 674c, and a fourth recess 674d all defined by different portions of the outer surface 628 and the inner surface 630. Each recess 674 may separate a lobe 672 of the four lobes 672 from another lobe 672 of the four lobes 672. For example, the first recess 674a may separate the first lobe 672a from the second lobe 672b, the second recess 674b may separate the second lobe 672b from the third lobe 672c, the third recess 674c may separate the third lobe 672c from the fourth lobe 672d, and the fourth recess 674d may separate the fourth lobe 672d from the first lobe 672a.

In some embodiments, the driveline 609 may be between about 5 feet and about 40 feet in length. In some embodiments, the driveline 609 may be a second section 620 of the driveline 609 that may be coupled to a first section (not shown) of the driveline 609. For example, the second section 620 may be coupled with the driveline 409 described with reference to FIGS. 4A–4E, which may be a first section. In some embodiments, the outer surface 628, the inner surface 630, the lobes 672, and the recesses 674 may at least partially define a cross-sectional geometry that may correspond with a cross-sectional geometry of the first section of the driveline 609. For example, the lobes 672 and the recesses 674 of the second section 620 may correspond with lobes and recesses of the first section. For example, the lobes 672 and the recesses 674 may correspond with the lobes 422 and the recesses 424 of the first section 418 described with respect to FIGS. 4A–4E such that at least a portion of the second section 620 fits within the first section 418 and rotation of either section transmits rotation to the other section.

As illustrated in FIGS. 6B and 6C, each lobe 672 and/or each recess 674 may be arranged symmetrically about a central axis 642 centered in and extending through the driveline 609. In some embodiments, each lobe 672 may be convex relative to the central axis 642. In some embodiments, each recess 674 may be concave relative to the central axis 642.

In these and other embodiments, the driveline 609 may include one or more interfaces 676. Each interface 676 may transition a recess 674 of the four recesses 674 into a lobe 672 of the four lobes 672. For example, each lobe 672 may be convex relative to the central axis 642, each recess 674 may be concave relative to the central axis 642, and each interface 676 may blend a curvature of a recess 674 into a curvature of an adjacent lobe 672. For instance, a first interface 676a may blend a curvature of the first recess 674a into a curvature of the first lobe 672a, and a second interface 676b may blend a curvature of the first recess 674a into a curvature of the second lobe 672b.

As illustrated in FIG. 6C, the outer surface 628 and the inner surface 630 of the driveline 609 may define a thickness 632 of the driveline 609. In some embodiments, the thickness 632 may be uniform. In some embodiments, the thickness 632 may be nonuniform. In some embodiments, and as illustrated in FIG. 6C, the thickness 632 of the driveline 609 at each interface 676 of the one or more interfaces 676 may be greater than the thickness 632 of the driveline 609 at the lobes 672 and/or the recesses 674. In some embodiments, the thickness 632 of the driveline 609 may be between about 1 millimeter and about 5 millimeters. For instance, the thickness 632 of the driveline 609 at the lobes 672, the recesses 674, and/or the interfaces 676 may be about 3.0 millimeters.

In some embodiments, a first distance from the central axis 642 to the portion of the outer surface 628 defining each lobe 672 may be between about 25 millimeters and about 35 millimeters. For example, the portion of the outer surface 628 defining each lobe 672 may define a portion of a circle 644, which may be centered with the central axis 642, and the distance from the central axis 642 to the outer surface 628 may be a radius 636 of the circle 644 that may be between about 20 millimeters and about 30 millimeters. For instance, the radius 636 of the circle 644 may be about 25.5 millimeters.

In some embodiments, the driveline 609 may be the second section 620 of the driveline 609, and the radius 636 may be between about 1 millimeter and about 5 millimeters less than a similar radius of the first section. For example, the driveline 609 may be the second section 620 of the driveline 609, the radius 636 may be about 25.5 millimeters, and the driveline 609 may be coupled to a first section such as the first section 418 of FIGS. 4A–4E, which may have a radius 436 of about 28 millimeters.

In some embodiments, a second distance from the central axis 642 to the portion of the inner surface 630 defining each lobe 672 may be the difference between the first distance from the central axis 642 to the portion of the outer surface 628 defining each lobe 672 and the thickness 632 at each lobe 672. For example, the portion of the inner surface 630 defining each lobe 672 may define a portion of another circle (not shown) with a radius 634 that may be the difference between the radius 636 of the circle 644 and the thickness 632. For instance, the radius 636 may be about 25.5 millimeters, the thickness 632 may be about 3.0 millimeters, and radius 634 may be about 22.5 millimeters.

In some embodiments, a minimum distance 638 between two points on the inner surface 630 may be between about 25 millimeters and about 40 millimeters. For example, the minimum distance 638 between the portion of the inner surface 630 defining the first recess 674a and the portion of the inner surface 630 defining the third recess 674c may be between about 25 millimeters and about 40 millimeters. For instance, the minimum distance 638 between two points on the inner surface 630 may be about 33 millimeters. In some embodiments, a minimum distance 640 between two points on the outer surface 628 may be between about 30 millimeters and about 45 millimeters. For example, the minimum distance 640 between the portion of the outer surface 628 defining the first recess 674a and the portion of the outer surface 628 defining the third recess 674c may be between about 30 millimeters and about 45 millimeters. In some embodiments, the thickness 632 may be uniform, and the minimum distance 640 between two points on the outer surface 628 may be the sum of the minimum distance 638 between two points on the inner surface 630 and twice the thickness 632. For example, the minimum distance 638 between two points on the inner surface 630 may be about 33 millimeters, the thickness 632 may be about 3.0 millimeters, and the minimum distance 640 between two points on the outer surface 628 may be about 39 millimeters.

In some embodiments, the driveline 609 may be the second section 620 of the driveline 609, the minimum distance 638 between two points on the inner surface 630 and/or the minimum distance 640 between two points on the outer surface 628 may be between about 1 millimeter and about 10 millimeters less than those distances of the first section. For example, the driveline 609 may be the second section 620 of the driveline 609, the minimum distance 638 between two points on the inner surface 630 may be about 33 millimeters, and the driveline 609 may be coupled to a first section such as the first section 418 of FIGS. 4A–4E, which may have a minimum distance 438 between two points on the inner surface 430 of about 39.6 millimeters.

In some embodiments, and as illustrated with respect to FIG. 6D, each recess 674 may be concave relative to the central axis 642 and convex relative to an external axis 654. For example, each recess 674 may be concave relative to the central axis 642, the first recess 674a may be convex relative to a first external axis 654a, the second recess 674b may be convex relative to a second external axis 654b, the third recess 674c may be convex relative to a third external axis 654c, and the fourth recess 674d may be convex relative to a fourth external axis 654d.

As illustrated in FIG. 6D and FIG. 6E, in some embodiments, a distance 646 from each external axis 654 to the portion of the outer surface 628 defining each recess 674 may be between about 5 millimeters and about 15 millimeters. For example, the distance 646 from each external axis 654 to the portion of the outer surface 628 defining each recess 674 may be about 11 millimeters. In some embodiments, each recess 674 may define a portion of a circle 664 centered with an external axis of the external axes 654, and the distance 646 may be a radius of the circle 664. For example, the outer surface 628 of the first recess 674a may define a portion of a circle 664a centered with the first external axis 654a, and the distance 646 may be a radius of the circle 664a between about 5 millimeters and about 15 millimeters. In some embodiments, a distance 648 from each external axis 654 to the portion of the inner surface 630 defining each recess 674 may be the sum of the distance 646 and the thickness 632 at each recess 674. For example, the distance 646 from each external axis 654 to the portion of the outer surface 628 defining each recess 674 may be about 11 millimeters, the thickness 632 may be about 3.0 millimeters, and the distance 668 from each external axis 654 to the portion of the inner surface 630 defining each recess 674 may be about 14 millimeters.

In some embodiments, a horizontal distance 656 between each external axis 654 may be between about 30 millimeters and about 60 millimeters. For example, the horizontal distance 656 between the external axes 654 may be about 43.1 millimeters. In some embodiments, the horizontal distance 658 between the central axis 642 and the external axes 654 may be between about 15 millimeters and about 30 millimeters. For example, the horizontal distance 658 between the central axis 642 and the external axes 654 may be about 21.6 millimeters. In some embodiments, the vertical distance 660 between the external axes 654 may be between about 30 millimeters and about 60 millimeters. For example, the vertical distance 660 between the external axes 654 may be about 43.1 millimeters. In some embodiments, the vertical distance 662 between the central axis 642 and the external axes 654 may be between about 15 millimeters and about 30 millimeters. For example, the vertical distance 662 between the central axis 642 and the external axes 654 may be about 21.6 millimeters.

In some embodiments, and as illustrated with respect to FIG. 6D and FIG. 6E, each interface 676 may have an outer radius 650 and an inner radius 652. In some embodiments, the outer radius 650 may be between about 1 millimeter and about 6 millimeters. For example, each interface 676 may have an outer radius 650 that may be between about 1 millimeter and about 6 millimeters from the center of a circle 666 to the portion of the outer surface 628 defining the interface 676. For instance, the outer radius 650 may be around 1.8 millimeters. In some embodiments, the inner radius 652 may be between about 1 millimeter and about 6 millimeters. For example, each interface 676 may have an inner radius 652 that may be between about 1 millimeter and about 6 millimeters from the center of a circle 667 to the portion of the inner surface 630 defining the interface 676. For instance, the inner radius 652 may be around 2 millimeters from the center of the circle 667 to the portion of the inner surface 630 defining the interface 676. In some embodiments, the inner radius 652 may be the difference between the outer radius 650 and the thickness 632.

Modifications, additions, or omissions may be made to the driveline 609 without departing from the scope of the present disclosure. For example, in some embodiments, the thickness 632 may be uniform. In some embodiments, the lobes 672, the recesses 674, and/or the interfaces 676 may not have a rounded shape. Furthermore, while both the lobes 672 and the recesses 674 are described as being symmetrically arranged about the central axis 642, it will be appreciated that manufacturing of the driveline 609 may be within certain tolerances such that the lobes 672 and the recesses 674 may not be perfectly symmetrically arranged about the central axis 642. Moreover, in some embodiments, the lobes 672 and/or the recesses 674 may be asymmetrically arranged about the central axis 642. While reference is made to the driveline 609 being a second section 620, it will be appreciated that the driveline 609 need not have multiple sections, and that the driveline 609 may represent the configuration of the entire length of the driveline 609.

Additionally, specific examples of dimensions are provided for exemplary purposes, and the dimensions may be larger or smaller than those given depending on the particular implementation of the driveline 609. Furthermore, it will be appreciated that any specific examples of dimensions are subject to manufacturing tolerances and, for example, may deviate from those provided by plus or minus 0.5 millimeters.

FIG. 7A and FIG. 7B respectively illustrate a perspective view and an exploded view of a portion of a driveline assembly 700 that may be implemented in a solar tracker system such as the solar tracker systems 100, 200, or 300 described with reference to FIG. 1, FIG. 2, and FIGS. 3A and 3B. The driveline assembly 700 may include a driveline 709 and a U-joint 714.

A first side 768 of the U-joint 714 may be configured to be coupled to the driveline 709. As illustrated in FIGS. 7A and 7B, in some embodiments, the first side 768 of the U-joint 714 may be a female component configured to receive the driveline 709, which may be a male component. In some embodiments, the driveline 709 may be a female component configured to receive the first side 768 of the U-joint 714. In some embodiments, the driveline 709 may have a first set of openings 719, and the U-joint 714 may have a second set of openings 771. In some embodiments, the first set of openings 719 of the driveline 709 and the second set of openings 771 of the U-joint 714 may be aligned when the U-joint 714 and the driveline 709 are coupled together. In these and other embodiments, a retention pin 770 may be inserted into the first set of openings 719 and the second set of openings 771 when the U-joint 714 and the driveline 709 are coupled to maintain the coupling between the U-joint 714 and the driveline 709 while the driveline 709 and the U-joint 714 rotate.

A second side 769 of the U-joint 714 may be configured to be coupled to a driveshaft. In some embodiments, the U-joint 714 may be configured to transmit a rotational force from the driveline 709 to a torque tube. For example, the second side 769 of the U-joint 714 may be coupled to the driveshaft of a gear drive mechanism, which may be coupled to a torque tube. The rotation of driveline 709 may cause the U-joint 714 to rotate, which in turn may cause the driveshaft of the gear drive mechanism to rotate thereby causing the torque tube to rotate. As a result, one or more PV modules coupled to the torque tube may be rotated. In some embodiments, the U-joint 714 may be configured to transmit a rotational force from the U-joint 714 to the driveline 709. For example, the second side 769 of the U-joint 714 may be coupled to a driveshaft of a motor or a driveshaft of a gear drive mechanism, and the U-joint 714 may transmit a rotational force from the motor or the gear drive mechanism to the driveline 709 causing the driveline 709 to rotate.

In some embodiments, the driveline 709 may include a second section 720 and a first section (not shown). For example, the second section 720 may be similar to the second section 620 described with reference to FIGS. 6A–6E and/or the second section 320 described with reference to FIG. 3. In some embodiments, the first side 768 of the U-joint 714 may be configured to receive the second section 720 of the driveline 709 or the second section 720 may be configured to receive the first side 768 of the U-joint 714. As illustrated in FIGS. 7A and 7B, the first side 768 of the U-joint 714 may be a female component configured to receive the second section 720, which may be a male component.

Modifications, additions, or omissions may be made to the driveline assembly 700 without departing from the scope of the present disclosure. For example, while a retention pin 770 is illustrated in FIGS. 7A and 7B as maintaining the coupling between the U-joint 714 and the driveline 709, it will be appreciated that other retention mechanisms may be utilized. For instance, a clamp, a friction-fit, a wedge fit, a rivet, an snap ring, a magnet, an adhesive, or other suitable retention mechanisms may be utilized. Furthermore, in some embodiments, the U-joint 714 may have male or female threads, the driveline 709 may have corresponding threads, and the U-joint 714 and the driveline 709 may be threadably coupled together. In these and other embodiments, the retention pin 770 may be omitted. Moreover, while the second side 769 of the U-joint 714 is illustrated as being configured to be coupled to a driveshaft, it will be appreciated that the second side 769 may be configured to be coupled to other components which may transmit a rotational force to the U-joint 714 or other components to which the U-joint 714 may transmit a rotational force.

Furthermore, the components illustrated in and described with reference to FIGS. 7A and 7B, may be similar to, have similar features as, or perform similar functions as similarly named components described throughout this disclosure. For example, the driveline 709 of the driveline assembly 700 may be similar to the drivelines described throughout this disclosure.

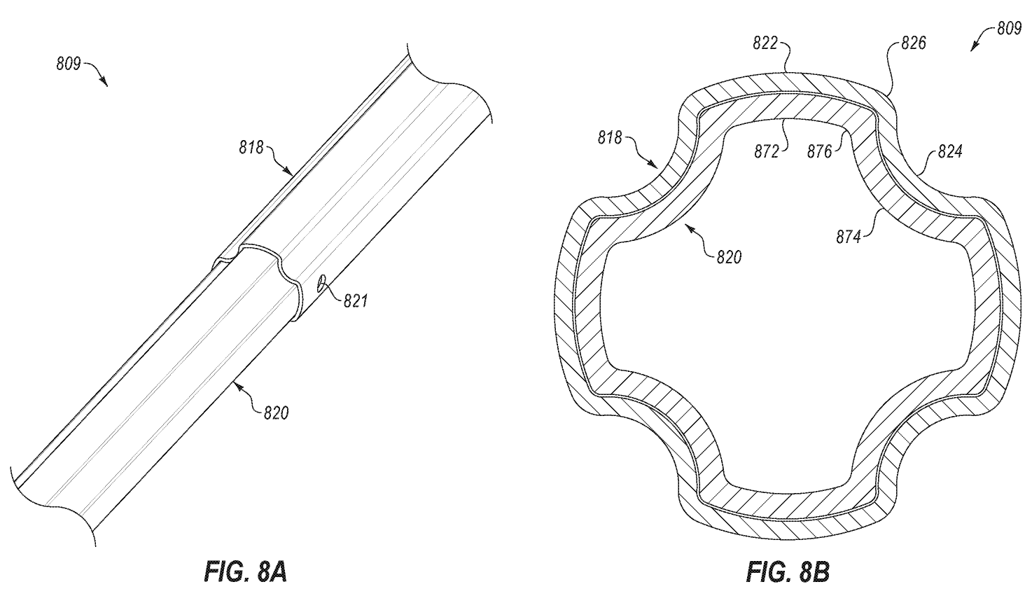

FIG. 8A and FIG. 8B respectively illustrate an example driveline 809 including a first section 818 and a second section 820 and a cross-sectional view of the example driveline 809. The example driveline 809 may be utilized in an example solar tracker system such as the solar tracker systems 100, 200, or 300 respectively described with reference to FIG. 1, FIG. 2, and FIGS. 3A and 3B. For example, the driveline 809 may be utilized in any of the driveline assemblies described throughout this disclosure.

As illustrated in FIG. 8A, the first section 818 of the driveline 809 and the second section 820 of the driveline 809 may be coupled together. In some embodiments, and as illustrated in FIGS. 8A and 8B, at least a portion of the second section 820 may fit within the first section 818 such that rotation of either section may transmit rotation to the other section. For example, the first section 818 may be a female component configured to receive the second section 820, which may be a male component. In some embodiments, at least a portion of the first section 818 may fit within the second section 820 such that rotation of either section may transmit rotation to the other section. For example, the second section 820 may be a female component configured to receive the first section 818, which may be a male component.

In some embodiments, the first section 818 may include one or more openings 821 and/or the second section 820 may include one or more openings (not shown). In some embodiments, a retention pin may be inserted into the openings 821 and the second set of openings when the first section 818 and the second section 820 are coupled to maintain the coupling between the first section 818 and the second section 820 while the driveline 809 rotates. In some embodiments, a set screw may be threaded into an opening of the one or more openings 821 to maintain the coupling between the first section 818 and the second section 820 while the driveline 809 rotates. In these and other embodiments, threading the set screw into the opening of the one or more openings 821 may tighten the fit between the first section 818 and the second section 820.

As illustrated in FIG. 8B, the first section 818 may have a cross-sectional geometry and the second section 820 may have a corresponding cross-sectional geometry to the cross-sectional geometry of the first section 818. The cross-sectional geometry of the first section 818 may be defined in part by an inner surface, an outer surface, four lobes 822, and four recesses 824. The four lobes 822 and the four recesses 824 may be arranged symmetrically about a central axis centered in and extending through the driveline 809. In some embodiments, the cross-sectional geometry of the first section 818 may be further defined by one or more interfaces 826, and each interface 826 may transition a recess 824 of the four recesses 824 into a lobe 822 of the four lobes 822. The first section 818 may include any or all of the features of the drivelines described throughout this disclosure. For example, the first section 818 may include any or all of the features of the driveline 409 described with reference to FIGA. 4A–4E, which may be a first section.

The corresponding geometry of the second section 820 may include an inner surface, an outer surface, four corresponding lobes 872, and four corresponding recesses 874. The four corresponding lobes 872 and the four corresponding recesses 874 may be arranged symmetrically about the central axis centered in and extending through the driveline 809. The four corresponding lobes 872 may correspond with the four lobes 822 such that each corresponding lobe 872 fits within a space defined at least in part by a lobe 822 of the four lobes 822. The four corresponding recesses 874 may correspond with the four recesses 824 such that each corresponding recess 874 fits within a space defined at least in part by a recess 824. In some embodiments, the corresponding cross-sectional geometry of the second section 820 may be further defined by one or more interfaces 876. The second section 820 may include any or all of the features of the drivelines described throughout this disclosure. For example, the second section 820 may include any or all of the features of the driveline 609 described with reference to FIGA. 6A–6E, which may be a second section.

In an example operation of the driveline 809, a rotational force may be transmitted to the driveline 809 causing the driveline 809 to rotate. In some embodiments, the rotational force may be initially transmitted to the second section 820 (e.g., the second section 820 is closer to the source of the rotational force than the first section 818), which may begin to rotate due to the rotational force. As the second section 820 rotates, the second section 820 may rotate within the first section 818, and the outer surface of the second section 820 may contact the inner surface of the first section 818 such that the rotational force may be transmitted from the second section 820 to the first section 818 causing the first section 818 to rotate. For example, as illustrated in FIG. 8B, the second section 820 may contact a portion of the inner surface of each of the recesses 824 of the first section 818, which may cause the first section 818 to rotate as the second section 820 is rotated. For instance, the second section 820 may have at least four points of contact with the first section 818 such that the shear stress from the rotational force may be distributed to the at least four points of contact. Thus, the shear stress may be distributed more efficiently between the first section 818 and the second section 820.

In some embodiments, the rotational force may be initially transmitted to the first section 818 (e.g., the first section 818 is closer to the source of the rotational force than the second section 820), which may begin to rotate due to the rotational force. As the first section 818 rotates, the inner surface of the first section 818 may contact the outer surface of the second section 820 within the first section 818 such that the rotational force may be transmitted from the first section 818 to the second section 820 causing the second section 820 to rotate. For example, as illustrated in FIG. 8B, the first section 818 may contact a portion of the outer surface of each of the corresponding recesses 874 of the second section 820, which may cause the second section 820 to rotate as the first section 818 is rotated. For instance, the first section 818 may have at least four points of contact with the second section 820 such that the shear stress from the rotational force may be distributed to the at least four points of contact. Thus, the shear stress may be distributed more efficiently between the first section 818 and the second section 820.

Modifications, additions, or omissions may be made to the driveline 809 without departing from the scope of the present disclosure. For example, although FIGS. 8A and 8B illustrate the second section 820 fitting within the first section 818, in some embodiments, the first section 818 may fit within the second section 820. Furthermore, the first section 818 and the second section 820 may be coupled in any suitable manner which may maintain the coupling of the first section 818 and the second section 820 while the driveline 809 is rotated. For example, the first section 818 may have male or female threads, the second section 820 may have corresponding threads, and the first section 818 and the second section 820 may be threadably coupled together.

Furthermore, the components illustrated in and described with reference to FIGS. 8A and 8B, may be similar to, have similar features as, or perform similar functions as similarly named components described throughout this disclosure. For example, the driveline 809 may be similar to the drivelines described throughout this disclosure.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more" to introduce claim recitations.

In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1-12. (canceled)

13. A solar tracker system, the solar tracker system comprising:
a first solar tracker row, the first solar tracker row including:
a first photovoltaic (PV) module;
a first torque tube coupled to the first PV module such that rotation of the first torque tube rotates the first PV module; and
a motor configured to exert a rotational force that rotates the first torque tube;
a second solar tracker row, the second solar tracker row including:
a second PV module; and
a second torque tube coupled to the second PV module such that rotation of the second torque tube rotates the second PV module; and
a first driveline assembly coupling the first solar tracker row to the second solar tracker row, the first driveline assembly including:
a first driveline configured to transmit the rotational force from the motor at the first solar tracker row to the second torque tube, the first driveline including:
an inner surface and an outer surface, the inner surface and outer surface defining a thickness of the first driveline;
four lobes defined by portions of the inner and outer surfaces, the four lobes arranged symmetrically about a central axis centered in and extending through the first driveline; and
four recesses defined by portions of the inner and outer surfaces, the four recesses arranged symmetrically about the central axis, each recess separating a lobe of the four lobes from another lobe of the four lobes;
a first universal joint (U-joint) coupling the first driveline to the motor, the first U- joint configured to transmit the rotational force from the motor to the first driveline; and
a second U-joint coupling the first driveline to the second solar tracker row, the second U-joint configured to transmit the rotational force from the first driveline to the second torque tube.

14. The solar tracker system of claim 13, wherein the first solar tracker row further comprises:
a first gear drive mechanism coupled to the first torque tube; and
wherein the second solar tracker row further comprises:
a second gear drive mechanism coupled to the second torque tube, the second U- joint configured to transmit the rotational force to the second gear drive mechanism such that the second gear drive mechanism causes the second torque tube to rotate.

15. The solar tracker system of claim 13, wherein the first solar tracker row is a middle row in the solar tracker system or an end row in the solar tracker system.

16. The solar tracker system of claim 13, the solar tracker system further comprising:
a third solar tracker row, the third solar tracker row including:
a third PV module; and
a third torque tube coupled to the third PV module such that rotation of the third torque tube rotates the third PV module;
a second driveline assembly coupling the second solar tracker row to the third solar tracker row, the second driveline assembly including:
a second driveline configured to transmit the rotational force from the first driveline to the third torque tube, the second driveline including:
an inner surface and an outer surface, the inner surface and outer surface defining a thickness of the second driveline;
four lobes defined by portions of the inner and outer surfaces, the four lobes arranged symmetrically about a central axis centered in and extending through the second driveline; and
four recesses defined by portions of the inner and outer surfaces, the four recesses arranged symmetrically about the central axis of the second driveline, each recess separating a lobe of the four lobes from another lobe of the four lobes;
a third U-joint coupling the second driveline to the second solar tracker row; and
a fourth U-joint coupling the second driveline to the third solar tracker row, the fourth U-joint configured to transmit the rotational force from the second driveline to the third torque tube.

17. The solar tracker system of claim 16, wherein the thickness of the second driveline is less than the thickness of the first driveline.

18. The solar tracker system of claim 13, wherein the first driveline further comprises a plurality of interfaces, each interface defined by portions of the inner and outer surfaces of the first driveline, each interface transitioning a recess of the four recesses into a lobe of the four lobes.

19. The solar tracker system of claim 13, wherein the inner surface of the first driveline, the outer surface of the first driveline, the four lobes of the first driveline, and the four recesses of the first driveline define, at least partially, a cross-sectional geometry of at least a portion of the first driveline; and
and wherein the first driveline further comprises:
a first section, the first section having the cross-sectional geometry; and
a second section coupled to the first section, the second section having a corresponding cross-sectional geometry to the cross-sectional geometry of the first section, the second section including:
four corresponding lobes and four corresponding recesses arranged symmetrically about the central axis such that at least a portion of the second section fits within the first section and rotation of either section transmits rotation to the other section.

20. (canceled)
